(19) United States
(12) Patent Application Publication
(10) Pub. No.: US 2021/0034973 A1
(43) Pub. Date: Feb. 4, 2021

(54) TRAINING NEURAL NETWORKS USING LEARNED ADAPTIVE LEARNING RATES

(71) Applicant: Google LLC, Mountain View, CA (US)

(72) Inventors: Zhen Xu, Mountain View, CA (US); Andrew M. Dai, San Francisco, CA (US); Jonas Beachey Kemp, Sunnyvale, CA (US); Luke Shekerjian Metz, Mountain View, CA (US)

(21) Appl. No.: 16/943,957

(22) Filed: Jul. 30, 2020

Related U.S. Application Data
(60) Provisional application No. 62/880,537, filed on Jul. 30, 2019.

(51) Int. Cl. G06N 3/08; G06N 3/04

(52) U.S. Cl. CPC G06N 3/08; G06N 3/0454

(57) ABSTRACT

Methods, systems, and apparatus, including computer programs encoded on computer storage media, for training a neural network. One of the methods includes training the neural network for one or more training steps in accordance with a current learning rate; generating a training dynamics observation characterizing the training of the trainee neural network on the one or more training steps; providing the training dynamics observation as input to a controller neural network that is configured to process the training dynamics observation to generate a controller output that defines an updated learning rate; obtaining as output from the controller neural network the controller output that defines the updated learning rate; and setting the learning rate to the updated learning rate.

### CROSS-REFERENCE TO RELATED APPLICATION

This application claims priority to U.S. Provisional Application No. 62/880,537, filed on Jul. 30, 2019. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that trains, using a learning rate prediction neural network, a trainee neural network to perform a particular neural network task.

Particular embodiments of the subject matter described in this specification can be implemented so as to realize one or more of the following advantages.

The learning rate is one of the most important hyper-parameters for model training and generalization. However, current hand-designed parametric learning rate schedules offer limited flexibility and the predefined learning rate schedule may not match the training dynamics of high dimensional and non-convex optimization problems, i.e., of the sort that are required to train large neural networks to perform well on real-world machine learning tasks. The described techniques, on the other hand, employ an adaptive learning rate schedule that leverages the information from past training histories. In other words, the learning rate dynamically changes based on the current training dynamics. Because of this, the auto-learned adaptive learning rate can achieve better results for any of a variety of tasks. In addition, the trained controller network is generalizable—able to be trained on one task and transferred to a new task on a different dataset. Thus, the described techniques can be employed to train large neural networks more efficiently, i.e., while consuming fewer computational resources, and to achieve superior performance on any of a variety of machine learning tasks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network training system.

FIG. 2 is a flow diagram of an example process for training the trainee neural network.

FIG. 3 is a flow diagram of an example process for training the controller neural network.

Like reference numbers and designations in the various drawings indicate like elements.

### DETAILED DESCRIPTION

This specification describes a system implemented as computer programs on one or more computers in one or more locations that trains a trainee neural network that is configured to perform a particular machine learning task.

The trainee neural network can be trained to perform any kind of machine learning task, i.e., can be configured to receive any kind of digital data input and to generate any kind of score, classification, or regression output based on the input.

In some cases, the trainee neural network is a neural network that is configured to perform an image processing task, i.e., receive an input image and to process the input image to generate a network output for the input image. For example, the task may be image classification and the output generated by the trainee neural network for a given image may be scores for each of a set of object categories, with each score representing an estimated likelihood that the image contains an image of an object belonging to the category. As another example, the task can be image embedding generation and the output generated by the trainee neural network can be a numeric embedding of the input image. As yet another example, the task can be object detection and the output generated by the trainee neural network can identify locations in the input image at which particular types of objects are depicted. As yet another example, the task can be image segmentation and the output generated by the trainee neural network can assign each pixel of the input image to a category from a set of categories.

As another example, if the inputs to the trainee neural network are Internet resources (e.g., web pages), documents, or portions of documents or features extracted from Internet resources, documents, or portions of documents, the task can be to classify the resource or document, i.e., the output generated by the trainee neural network for a given Internet resource, document, or portion of a document may be a score for each of a set of topics, with each score representing an estimated likelihood that the Internet resource, document, or document portion is about the topic.

As another example, if the inputs to the trainee neural network are features of an impression context for a particular advertisement, the output generated by the trainee neural network may be a score that represents an estimated likelihood that the particular advertisement will be clicked on.

As another example, if the inputs to the trainee neural network are features of a personalized recommendation for a user, e.g., features characterizing the context for the recommendation, e.g., features characterizing previous actions taken by the user, the output generated by the trainee neural network may be a score for each of a set of content items, with each score representing an estimated likelihood that the user will respond favorably to being recommended the content item.

As another example, if the input to the trainee neural network is a sequence of text in one language, the output generated by the trainee neural network may be a score for each of a set of pieces of text in another language, with each score representing an estimated likelihood that the piece of text in the other language is a proper translation of the input text into the other language.

As another example, the task may be an audio processing task. For example, if the input to the trainee neural network is a sequence representing a spoken utterance, the output generated by the trainee neural network may be a score for each of a set of pieces of text, each score representing an estimated likelihood that the piece of text is the correct transcript for the utterance. As another example, the task may be a keyword spotting task where, if the input to the trainee neural network is a sequence representing a spoken utterance, the output generated by the trainee neural network can indicate whether a particular word or phrase (“hotword”) was spoken in the utterance. As another example, if the input to the trainee neural network is a sequence representing a spoken utterance, the output generated by the trainee neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

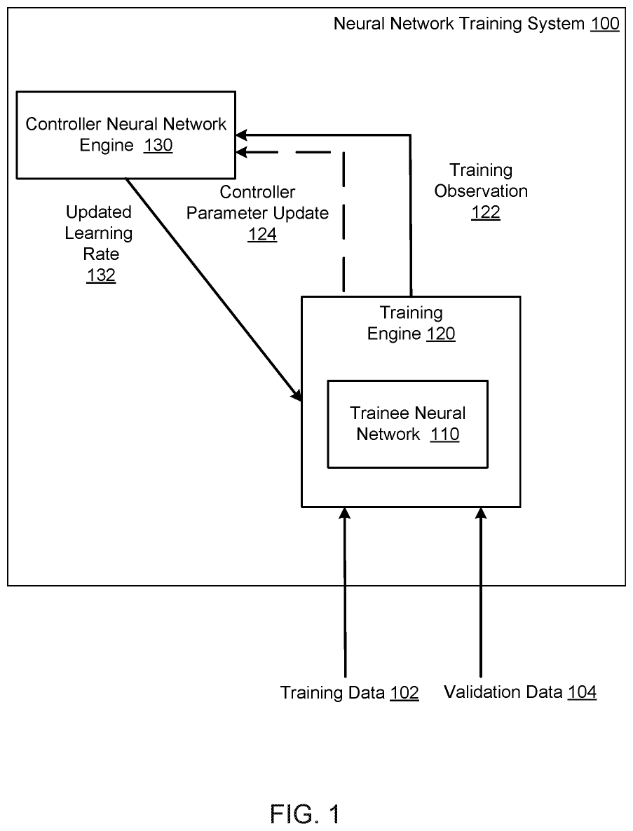

FIG. 1 shows an example neural network training system 100. The neural network training system 100 is an example of a system implemented as computer programs on one or more computers in one or more locations, in which the systems, components, and techniques described below can be implemented.

The neural network training system 100 is a system that obtains training data 102 for training a trainee neural network 110 to perform a particular task and a validation set 104 for evaluating the performance of the trainee neural network 110 on the particular task and uses the training data 102 and the validation set 104 to train the trainee neural network 110.

Generally, the training data 102 and the validation set 104 both include a set of neural network inputs and, for each network input, a respective target output that should be generated by the trainee neural network to perform the particular task. For example, a larger set of training data may have been randomly partitioned to generate the training data 102 and the validation set 104. In some cases, e.g., when the system is training the trainee neural network 110 using a semi-supervised learning scheme, the training data 120 may include additional network inputs for which no target output is available.

The system 100 can receive the training data 102 and the validation set 104 in any of a variety of ways. For example, the system 100 can receive training data as an upload from a remote user of the system over a data communication network, e.g., using an application programming interface (API) made available by the system 100, and randomly divide the uploaded data into the training data 102 and the validation set 104. As another example, the system 100 can receive an input from a user specifying which data that is already maintained by the system 100 should be used for training the trainee neural network, and then divide the specified data into the training data 102 and the validation set 104.

The trainee neural network 110 is a neural network having a set of parameters (“trainee parameters”) and that is configured to process network inputs in accordance with the trainee parameters to generate an output for the particular task. The trainee neural network 110 can have any appropriate architecture that allows the neural network 110 to receive network inputs of the type required by the particular task and to generate network outputs of the form required for the particular task. Examples of trainee neural networks 110 that can be trained by the system 100 include fully-connected neural networks, convolutional neural networks, recurrent neural networks, attention-based neural networks, e.g., Transformers, and so on.

Generally, a training engine 120 within the system 100 trains the trainee neural network 110 on the training data 102 using gradient descent.

In a gradient descent training technique, at each training step, the training engine 120 computes a gradient of an objective function with respect to the trainee network parameters and on a batch of training inputs selected from the training data 102, applies a learning rate to the computed gradient to determine a parameter value update, and then applies the parameter value update to the current values of the trainee parameters of the trainee neural network, i.e., by subtracting or adding the parameter value update with the current parameter values.

By repeatedly performing training steps, the training engine 120 repeatedly updates the values of the trainee parameters to improve the performance of the trainee neural network 110 on the particular task.

The manner in which the training engine 120 determines the parameter value update, i.e., how the training engine 120 applies the learning rate to the computed gradient, is dependent on the optimizer that is being used in the training.

For example, in stochastic gradient descent, the update is a product of the learning rate and the gradient.

As another example, in the Adam optimizer, the update is a product of the learning rate and an exponentially decayed average of past gradients.

As another example, in the Adagrad optimizer, the system first adapts the learning rate per weight, i.e., per trainee network parameter, based on the sums of the squares of the gradients and then computes, for each trainee parameter, a product of the gradient with respect to the parameter and the adapted learning rate.

Nonetheless, all of these optimizers require a global learning rate. In conventional systems, this global learning rate is either held fixed throughout training or adjusted during the training using a manually determined schedule.

Unlike in conventional systems, the training engine 120 determines the learning rate that is used at any given training step using a controller neural network 130.

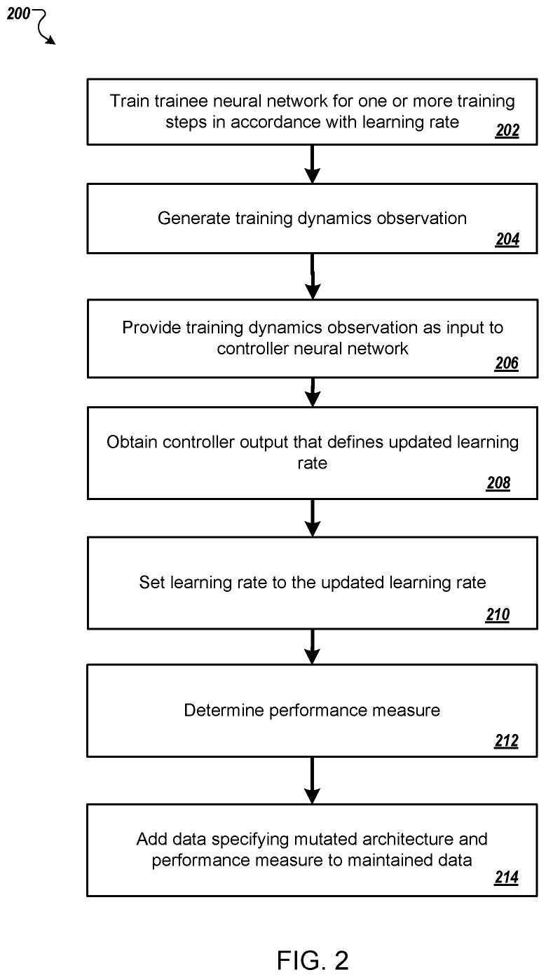

The controller neural network 130 is a neural network having parameters (“controller parameters”) and that is configured to receive as input a training dynamics observation 122 that characterizes the training of the trainee neural network 110 over a most recent set of one or more training steps and to generate an output that defines the updated learning rate 132 that will be used in the next set of one or more training steps. Generally, the training dynamics observation 122 is a collection, e.g., a concatenation, of features characterizing the training of the trainee neural network 110. Examples of features that can be included in the training dynamics observation 122 are described below with reference to FIG. 2.

For example, the output of the controller 130 can be a scaling factor that is applied to the most recent learning rate to generate the updated learning rate. In other words, the updated learning rate 132 is the product of the most recent learning rate and the output of the controller 130.

The controller 130 can have any appropriate neural network architecture that allows the controller 130 to map a collection of features to a scaling factor or other output that defines an updated learning rate. For example, the controller 130 can be a multi-layer perceptron (MLP). As another example, the controller 130 can be a recurrent neural network (RNN) that processes each training dynamics observation in accordance with a current internal state to generate the controller output and to update the current internal state at each time step during the training of the trainee neural network 110.

Thus, after each set of one or more training steps is completed during the training of the trainee neural network, the system 100 uses the controller neural network to generate an updated learning rate 132 and then uses that updated learning rate 132 for the next set of one or more training steps.

Training the trainee neural network 110 using outputs from the controller 130 is described in more detail below with reference to FIG. 2.

In some cases, the system 100 trains the controller neural network during the training of the trainee neural network, i.e., by repeatedly updating the values of the controller parameters through reinforcement learning to optimize rewards that are based on the performance of the trainee neural network 110 as it is being trained.

In some other cases, the system 100 (or another system) has already trained the controller neural network 130 during the training of a different neural network, e.g., a neural network having a different architecture from the trainee neural network 110. That is, once the controller 130 has been trained, the learning rates generated by the controller 130 are transferable to improve the training of other neural networks (i.e., neural networks that are different from the one that was used in the training of the controller) without needing to further train the controller 130.

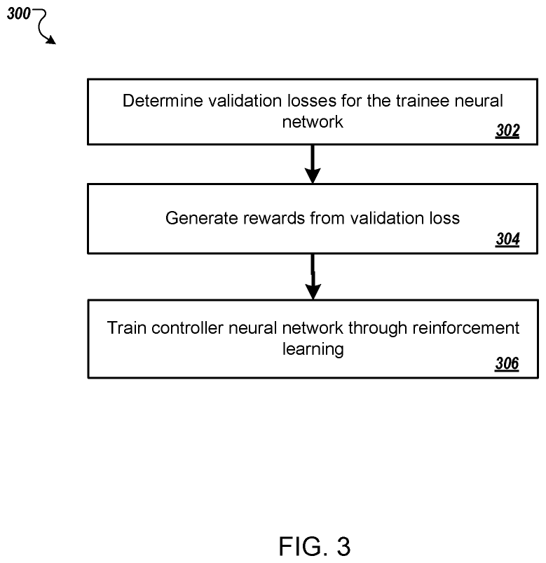

Training the controller 130 is described below with reference to FIG. 3.

In some implementations, after the trainee neural network 110 has been trained, the system 100 deploys the trained neural network and then uses the trained neural network to process requests received from users, e.g., through the API provided by the system. In other words, after training, the system uses the trained trainee neural network 110 to generate new network outputs for new network inputs.

Instead of or in addition to using the trained neural network 110, the system 100 can provide data specifying the final trainee parameter values to a user who submitted a request to train the trainee neural network, e.g., through the API.

FIG. 2 is a flow diagram of an example process 200 for training the trainee neural network. For convenience, the process 200 will be described as being performed by a system of one or more computers located in one or more locations. For example, a neural network training system, e.g., the neural network training system 100 of FIG. 1, appropriately programmed, can perform the process 200.

The system can repeatedly perform the process 200 on different batches of training data to determine trained values of the trainee parameters, i.e., by repeatedly updating the current values of the trainee parameters. For example, the system can continue performing the process 200 until a threshold number of iterations of the process have been performed, until a threshold amount of time has elapsed, or until the values of the trainee parameters have converged.

The system trains the trainee neural network for one or more training sets in accordance with the current learning rate (step 202). Each training step corresponds to the training of the neural network on a batch of training data to update the values of trainee parameters. That is, each training step corresponds to an update of the trainee parameters.

In more detail, at each training step, the system receives a plurality of training inputs, e.g., a batch of training inputs that have been sampled from the training data and determines, based on processing the training inputs using the trainee neural network and in accordance with current values of the trainee parameters, a gradient of an objective function with respect to the trainee network parameters. The objective function can be any appropriate objection function for the particular task. Examples of objective functions include cross-entropy losses, mean squared error losses, L2 distance losses, log likelihood objectives, and so on.

The system then applies the current learning rate to the gradient to generate a trainee parameter value update and updates the current values of the trainee network parameters by applying the trainee parameter value update to the current values of the trainee parameters. As described above, the manner in which the system generates the trainee parameter value update will depend on the optimizer that is being used for the training. For example, in stochastic gradient descent the system can multiply the gradient by the current learning rate to generate the update. As another example, when using the Adam optimizer the system can determine a modified gradient based on the current gradient and one or more recently computed gradients and then multiply the modified gradient by the current learning rate.

The system generates a training dynamics observation characterizing the training of the trainee neural network on the one or more training steps (step 204). Generally, the training dynamics observation is a collection of features, e.g., a concatenation of feature vectors, that characterize the training and are informative about how the training is progressing as of the one or more training steps.

The training dynamics observation can include any of a variety of features.

As one example, the training dynamics observation can include the learning rate used for the one or more training steps.

As another example, the training dynamics observation can include a feature that is based on a current training loss of the trainee neural network on the training inputs for the one or more training steps. That is, the system can compute the sum or the average of the loss (i.e., the value of the objective function) computed for each of the training inputs over the one or more training steps and use the computed average or sum as one of the features.

As another example, the training dynamics observation can include a feature that is based on a current validation loss of the trainee neural network on the validation data. That is, after the one or more training steps, the system can process each validation input in the validation data set or in a subset of the validation data set using the trainee neural network and compute a loss for each processed validation input. The system can then use the sum or the average of these losses as one of the features.

As another example, the training dynamics observation can include a feature that is based on statistics of the updated values of the parameters of a designated layer in the trainee neural network. For example, the system can compute one or more moments, e.g., the mean, variance, or both, of the updated values of the parameters of a designated layer designated layer and use the computed moments as features.

As another example, the training dynamics observation can include one or more features that are each based on outputs generated by the trainee neural network for the training inputs for the one or more training steps. For example, the system can compute the variance of the outputs generated by the trainee neural network in accordance with the updated values of the trainee parameters after the one or more steps for the training inputs for the one or more training steps and use the variance or a value derived from the variance as a feature. As another example, the system can compute the variance of the outputs generated by the trainee neural network in accordance with the current values of the trainee parameters before the one or more steps for the training inputs for the one or more training steps and use the variance or a value derived from the variance as a feature. As yet another example, the system can compute, for each training input, a difference between (i) the output generated for the training input by the trainee neural network in accordance with the updated values of the trainee parameters and (ii) the output generated for the training input by the trainee neural network in accordance with the current values of the trainee parameters. The system can then compute the variance of the differences for the training inputs and use the variance or a value derived from the variance as a feature.

As another example, the training dynamics observation can include a feature that is based on the training inputs for the one or more steps. For example, the system can compute one or more moments, e.g., the mean, variance, or both, of the training inputs and use the computed moments as features.

The system provides the training dynamics observation as input to a controller neural network that is configured to process the training dynamics observation to generate a controller output that defines an updated learning rate (step 206).

For example, the output of the controller can be a scaling factor that is applied to the most recent learning rate to generate the updated learning rate. In other words, the updated learning rate is the product of the most recent learning rate and the output of the controller.

In more detail, the learning rate is very sensitive and the optimal learning rate at any given time during training could be in the 10⁻⁶ scale or even smaller. Thus, it may make the training very unstable to directly use the controller output as the learning rate.

Another choice of controller output could be outputting the log of the learning rate. However, in implementations in which the controller is required to be generalizable to different data sets and different trainee neural networks, different training schemes may require different learning rate scales and outputting the log of the learning rate may not result in a controller that is transferrable to different training schemes.

Instead, the controller can output a scaling factor. At the first iteration of the process 200, a default learning rate is used for the training of the trainee neural network. In the following iterations, the controller output is the scaling factor for the most recent learning rate, which can scale it up or down. In this case, the controller can provide both warm up and decay capabilities in a stable way. Outputting the scaling factor can provide a better inductive bias keeping learning consistent across steps and allowing the controller to generalize to different training schemes. The default learning rate can be provided as input to the system or can be determined by the system by performing a conventional hyperparameter search.

The system obtains as output from the controller neural network the controller output that defines the updated learning rate (step 208).

The system then sets the learning rate to the updated learning rate (step 210), i.e., so that the learning rate used for the training of the trainee neural network during the next iteration of the process 200 will be the updated learning rate.

FIG. 3 is a flow diagram of an example process 300 for training the controller neural network. For convenience, the process 300 will be described as being performed by a system of one or more computers located in one or more locations. For example, a neural network training system, e.g., the neural network training system 100 of FIG. 1, appropriately programmed, can perform the process 300.

The system can repeatedly perform the process 300 whenever certain criteria are satisfied during the training of a trainee neural network to update the values of the controller parameters. For example, the system can perform the process 300 after a threshold number of training steps have been performed since a preceding iteration of the process 300 or after a threshold number of iterations of the process 200 have been performed since the preceding iteration of the process 300.

Once the controller neural network 300 has been trained by repeatedly performing the process 300 during the training of one trainee neural network, the controller neural network can be used (without re-training) to generate learning rates for the training of a new trainee neural network, even if the new trainee neural network has a difference architecture or is being trained on a different data set or both.

The system determines one or more validation losses for the trainee neural network (step 302). In particular, the system can compute a respective validation loss after each iteration of the process 200, as described above. Thus, if the system performs N iterations of the process 200 between each iteration of the process 300, the system would compute N validation losses, one for each time that the learning rate of the neural network was updated since the previous time that the controller parameters were updated.

The system generates a respective reward for each validation loss (step 304). For example, the respective reward can be equal to the negative of the validation loss or can otherwise be inversely proportional to the validation loss.

The system trains the controller neural network through reinforcement learning (step 306) using the rewards. In particular, the system trains the controller neural network through reinforcement learning on tuples that each include a training dynamics observation, a controller output that defines a learning rate that was generated as a result of processing the training dynamics observation using the controller output, and a reward signal that is generated from the validation loss computed after the trainee neural network was trained for one or more steps with the learning rate defined by the controller output.

In particular, the system updates the values of the parameters of the controller neural network by training, based on the rewards, the controller neural network through reinforcement learning to maximize an objective function that measures the expected time discounted reward during the training of the trainee neural network.

More specifically, because the validation losses are non-differentiable, the system computes the updates using a policy gradient reinforcement learning technique. As one particular example, the policy gradient reinforcement learning technique can be proximal policy optimization (PPO). As another particular example, the policy gradient reinforcement learning technique can be REINFORCE.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a trainee neural network having a plurality of trainee parameters by repeatedly adjusting values of the trainee network parameters, the method comprising repeatedly performing operations comprising:
training the trainee neural network for one or more training steps, the training comprising, at each training step:
receiving a plurality of training inputs;
determining, based on processing the training inputs using the trainee neural network and in accordance with current values of the trainee parameters, a gradient of an objective function with respect to the trainee network parameters;
applying a learning rate to the gradient to generate a trainee parameter value update; and
updating the current values of the trainee network parameters by applying the trainee parameter value update to the current values of the trainee parameters;
generating a training dynamics observation characterizing the training of the trainee neural network on the one or more training steps;
providing the training dynamics observation as input to a controller neural network that is configured to process the training dynamics observation to generate a controller output that defines an updated learning rate;
obtaining as output from the controller neural network the controller output that defines the updated learning rate; and
setting the learning rate to the updated learning rate.

2. The method of claim 1, wherein the controller output is a scaling factor to be applied to the learning rate used for the one or more training steps to generate the updated learning rate.

3. The method of claim 1, wherein training dynamics observation comprises the learning rate used for the one or more training steps.

4. The method of claim 1, wherein the training dynamics observation comprises a feature that is based on a current training loss of the trainee neural network on the training inputs for the one or more training steps.

5. The method of claim 1, wherein the training dynamics observation comprises a feature that is based on a current validation loss of the trainee neural network on validation data.

6. The method of claim 1, wherein the training dynamics observation comprises a feature that is based on statistics of the updated values of the parameters of a designated layer in the trainee neural network.

7. The method of claim 1, wherein the training dynamics observation comprises one or more features that are each based on outputs generated by the trainee neural network for the training inputs for the one or more training steps.

8. The method of claim 1, wherein the training dynamics observation comprises a feature that is based on statistics of the training inputs for the one or more training steps.

9. The method of claim 1, wherein the controller neural network has been trained jointly with the training of a second, different neural network that has a different architecture from the trainee neural network and the values of the parameters of the controller neural network are fixed during the training of the trainee neural network.

10. The method of claim 1, the operations further comprising:
obtaining one or more rewards that measure the performance of the trainee neural network after the one or more training steps; and
updating the values of the parameters of the controller neural network by training, based on the reward, the controller neural network through reinforcement learning to maximize an objective function that measures the expected time discounted reward during the training of the trainee neural network.

11. The method of claim 10, wherein the reward is based on a validation loss of the trainee neural network after the training for the one or more training steps.

12. The method of claim 10, wherein training the controller neural network comprises training the trainee neural network using a policy gradient reinforcement learning technique.

13. The method of claim 12, wherein the policy gradient reinforcement learning technique is proximal policy optimization (PPO).

14. A system comprising one or more computers and one or more storage devices storing instructions that when executed by the one or more computers cause the one or more computers to train a trainee neural network having a plurality of trainee parameters by repeatedly performing operations to adjust values of the trainee network parameters, the operations comprising:
training the trainee neural network for one or more training steps, the training comprising, at each training step:
receiving a plurality of training inputs;
determining, based on processing the training inputs using the trainee neural network and in accordance with current values of the trainee parameters, a gradient of an objective function with respect to the trainee network parameters;
applying a learning rate to the gradient to generate a trainee parameter value update; and
updating the current values of the trainee network parameters by applying the trainee parameter value update to the current values of the trainee parameters;
generating a training dynamics observation characterizing the training of the trainee neural network on the one or more training steps;
providing the training dynamics observation as input to a controller neural network that is configured to process the training dynamics observation to generate a controller output that defines an updated learning rate;
obtaining as output from the controller neural network the controller output that defines the updated learning rate; and
setting the learning rate to the updated learning rate.

15. The method of claim 1, wherein the controller output is a scaling factor to be applied to the learning rate used for the one or more training steps to generate the updated learning rate.

16. The method of claim 1, wherein training dynamics observation comprises the learning rate used for the one or more training steps.

17. The method of claim 1, wherein the training dynamics observation comprises a feature that is based on a current training loss of the trainee neural network on the training inputs for the one or more training steps.

18. The method of claim 1, wherein the training dynamics observation comprises a feature that is based on a current validation loss of the trainee neural network on validation data.

19. The method of claim 1, wherein the training dynamics observation comprises a feature that is based on statistics of the updated values of the parameters of a designated layer in the trainee neural network.

20. One or more non-transitory computer-readable storage media storing instructions that when executed by one or more computers cause the one or more computers to train a trainee neural network having a plurality of trainee parameters by repeatedly performing operations to adjust values of the trainee network parameters, the operations comprising:
training the trainee neural network for one or more training steps, the training comprising, at each training step:
receiving a plurality of training inputs;
determining, based on processing the training inputs using the trainee neural network and in accordance with current values of the trainee parameters, a gradient of an objective function with respect to the trainee network parameters;
applying a learning rate to the gradient to generate a trainee parameter value update; and
updating the current values of the trainee network parameters by applying the trainee parameter value update to the current values of the trainee parameters;
generating a training dynamics observation characterizing the training of the trainee neural network on the one or more training steps;
providing the training dynamics observation as input to a controller neural network that is configured to process the training dynamics observation to generate a controller output that defines an updated learning rate;
obtaining as output from the controller neural network the controller output that defines the updated learning rate; and
setting the learning rate to the updated learning rate.
